(19) United States
(12) Patent Application Publication
(10) Pub. No.: US 2023/0091215 A1
(43) Pub. Date: Mar. 23, 2023

(54) NOVEL SYSTEM AND METHOD FOR BOOKING EVENTS

(71) Applicant: KAVITA RAMCHANDANI SNYDER, Capitola, CA (US)

(72) Inventor: KAVITA RAMCHANDANI SNYDER, Capitola, CA (US)

(21) Appl. No.: 16/991,070

(22) Filed: Aug. 12, 2020

(51) Int. Cl. G06Q 10/02; G06Q 30/0203; G06Q 30/0202; G06Q 50/00; G06Q 30/0251; G06Q 20/10

(52) U.S. Cl. CPC G06Q 10/02; G06Q 30/0203; G06Q 30/0202; G06Q 50/01; G06Q 30/0259; G06Q 30/0255; G06Q 20/10

(57) ABSTRACT

The present invention includes a system and method for booking live events is disclosed herein. The scheduler initiates a first set of inquiry notification for an event and sends the inquiry notification to one or more user subscribers on a network. In addition, the scheduler receives indications of interest to attend the event in response to sending the first set of inquiry notifications. Further, the scheduler determines whether to schedule the event based upon metrics associated with the received indications of interest. The scheduler may also book the talent for the event when the metrics associated with the received indications of interest meet a pre-defined threshold. In some examples, the scheduler prompts a user subscriber that initiated the inquiry notification for a deposit payment as a condition to send the first set of inquiry notifications to the one or more user subscribers on the network.

### FIELD

The present invention relates to a system and method for booking events.

### BACKGROUND

Tour promoters organize live concert tours and special event performances. Among tour promoter‘s’ job responsibilities include obtaining venues, concert halls, theaters, night clubs and arena bookings; determining event or tour prices; and providing transportation services. Often times, tour promoters need upfront cash and sponsorship financing to pay for advertising and other related costs. If turnout is low, however, tour promoters risk losing its investment as the obligation to pay the costs remain. Moreover, tour promoters often lack real-time, granular data regarding the precise interests of fans to attend events. Accordingly, a need exists for an improved event booking and reservation system.

### BRIEF DESCRIPTION OF THE DRAWINGS

To facilitate understanding, identical reference numerals have been used, wherever possible, to designate identical elements that are common to the figures. The drawings are not to scale and the relative dimensions of various elements in the drawings are depicted schematically and not necessarily to scale. The techniques of the present invention may readily be understood by considering the following detailed description in conjunction with the accompanying drawings, in which:

FIG. 1 is an example computer network system according to one or more examples of the present invention;

FIG. 2 is a system for booking events according to one or more examples of the present invention; and

FIGS. 3-7 are illustrations of computing systems according to one or more examples of the present invention.

### DETAILED DESCRIPTION

Before the present invention is described in detail, it is to be understood that, unless otherwise indicated, this disclosure is not limited to specific procedures or articles, whether described or not.

It is further to be understood that the terminology used herein is for the purpose of describing particular embodiments only and is not intended to limit the scope of the present invention.

It must be noted that as used herein, and in the claims, the singular forms “a,” and “the” include plural referents unless the context clearly dictates otherwise.

Where a range of values is provided, it is understood that each intervening value, to the tenth of the unit of the lower limit unless the context clearly dictates otherwise, between the upper and lower limit of that range, and any other stated or intervening value in that stated range, is encompassed within the disclosure. The upper and lower limits of these smaller ranges may independently be included in the smaller ranges, and are also encompassed within the disclosure, subject to any specifically excluded limit in the stated range. Where the stated range includes one or both of the limits, ranges excluding either or both of those included limits are also included in the disclosure. The term “about” generally refers to ±10% of a stated value.

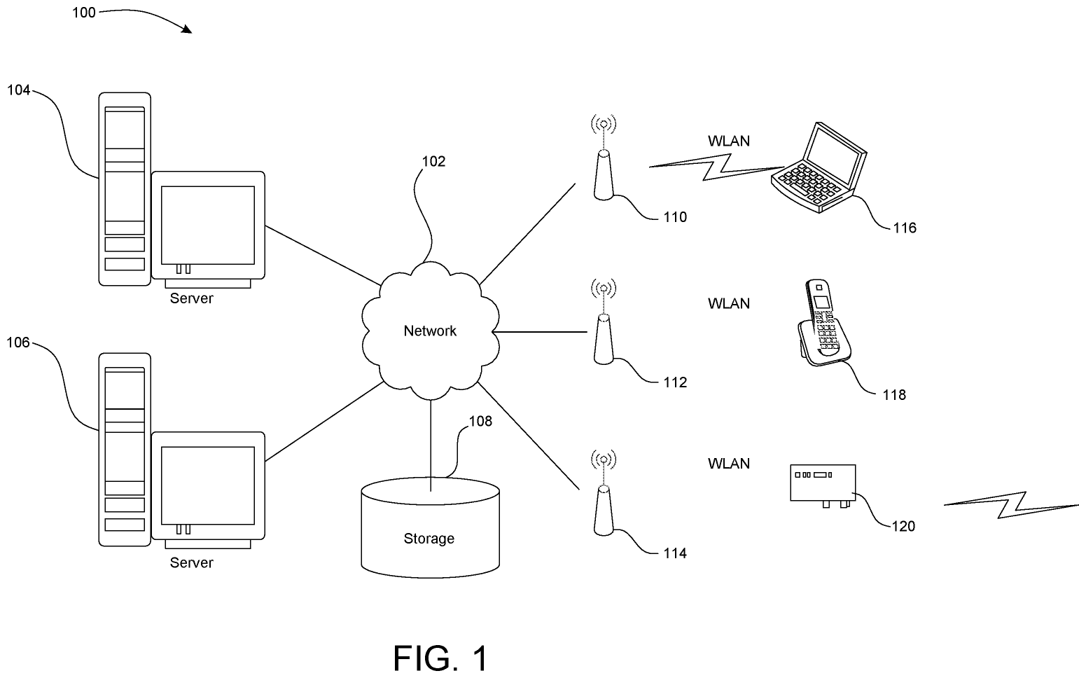

FIG. 1 is an example computer network system 100 according to one or more examples of the present invention. Computer network system 100 is a network of data processing systems, such as, for example, computers and other devices, in which the illustrative embodiments may be implemented. One or more client devices employed within computer network system 100 may include a display screen, a plurality of microprocessors, and memory.

Computer network system 100 may include one or more networks which provide communication links between the various computers and other devices connected together within the computer network system 100. In some implementations, network 102 may include connections, such as wire(s), wireless communication links, or fiber optic cables.

In the example depicted in computer network system 100, a server 104, server 106, and storage unit 108 are all connected to network 102. Storage unit 108 may be capable of storing data in a structured or unstructured format. Additionally, storage unit 108 may represent a plurality of storage units coupled to network 102. In some implementations of the present invention, the storage unit 108 may, for example, include any database within an enterprise that stores and manages reusable software assets and any other data related to these reusable software assets. Access Points 110, 112, and 114 may function as a network device that allows client device to connect to a wired network. In some implementations, an access point may connect to a router as a standalone device but may also be an integral component of the router itself in some implementations.

In addition, the access points 110, 112, 114 may provide wireless access to client devices 116, 118, 120. The client devices may include personal computers, network computers, laptop computers, hand-held computers, personal digital assistants (PDAs), or smart cellular telephones (e.g., smartphones). However, one having ordinary skill in the art should appreciate that the present invention is not limited to the client devices is not limited to the aforementioned devices.

In the implementation shown, access points 110, 112, and 114 are clients to server 104 and/or server 106. In addition, server 104 and/or server 106 may provide data, such as, for example, boot files, operating system images, and applications to access points 110, 112, and 114. Moreover, computer network system 100 may include additional servers, clients, and other devices not shown to implement processes of illustrative implementations.

Computer network system 100 may be implemented as a number of different types of networks, such as, for example, an intranet, a local area network (LAN), a wide area network (WAN), or the Internet. Also, it should be noted that FIG. 1 is only intended as an example and not as an architectural limitation for the different illustrative implementations. For example, illustrative implementations may be implemented within a single data processing system or within a computer network system.

The present invention provides a novel system and method for booking events. The events may include a concert for talent (e.g., a recording artist), a competition, a political fundraiser, a social rally, etcetera. Notably, the present invention provides a platform for a network of user subscribers to initiate a set of inquiry notifications for an event for a talent's performance. The events may include live or virtual events. In addition, the present invention allows talent to create and then send set of inquiry notifications to a network of user subscribers that are in specific geographies (i.e., geos) to gauge interest for a showing or performance.

Herein, a geo is defined as a geographic area, city, region, etcetera. In some examples, a geo may define a virtual perimeter (e.g., geofence) wherein user subscribers therein are sent inquiry notifications as explained in more detail below. Furthermore, it should be understood by one having ordinary skill in the art that more than one inquiry notification may be sent to user subscribers within a network. In some implementations, an inquiry notification includes the specific date and time options for an event in addition to one or more venue options for the event.

The present invention also provides a platform for vendor personnel to create and then send inquiry notifications to a network of user subscribers that are in specific geos to gauge an interest for a showing or performance for specific dates and times. In one implementation, vendor personnel are assigned specific geos to initiate inquiry notifications which are sent to a network of user subscribers in geos of interest. For example, vendor personnel in San Francisco, CA can initiate inquiry notifications in geos which are in the San Francisco Bay Area. In this example, vendor personnel can send inquiry notifications to a network of user subscribers within, for example, 50 miles of San Francisco, Calif.

Advantageously, the present invention facilitates the capability of fans to schedule events to see its favorite talent (e.g., artists) instead of waiting for tour promoters to book these artists for shows. The present invention may be particularly useful for fans to schedule events for lesser-known artists, at their preference, so long as there is sufficient fan (e.g., user subscriber) interest in a particular geo. The present invention also provides a platform for talent to reserve blocks of dates and times (e.g., summer months) such that user subscribers can schedule events for talent performances so long as a pre-defined criteria is met, as further described below.

Accordingly, the present invention provides a system and method for booking talent (e.g., a recording artist) for a live concert for specific dates and times. The scheduler can initiate inquiry notifications for events and then send the inquiry notifications to select groups of user subscribers. Furthermore, a scheduler can receive indications of interest to attend the event in response to submitted inquiry notifications. The scheduler can further determine whether to schedule an event based upon metrics associated with the received indications of interest. Accordingly, the scheduler can schedule an event which includes booking talent if the metrics associated with the indications of interest meet or exceed a pre-defined threshold.

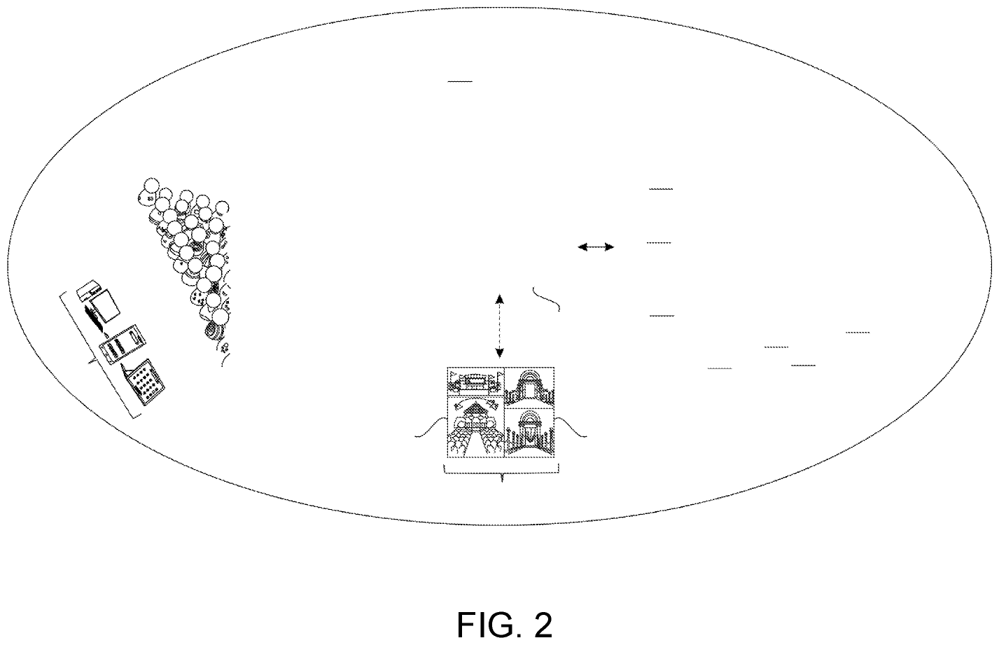

FIG. 2 is a system 200 for booking events according to one or more examples of the present invention. As shown, system 200 includes a plurality of client devices 202 which enable user subscribers 201 on a network to engage with a calendaring system 203 which hosts pre-reservations for a talent platform 204 of talent, events, projects, etcetera to be hosted at a venue listed within the system 200. The one or more venues can host events, performances, and competitions for events. The system 200 described herein can enable talent, subscribers, event organizers, project leaders, and venue personnel to initiate inquiry notifications to determine a level of interest for proposed events.

For example, talent platform 204 may include profiles of musicians 212, chefs 206, athletes (e.g., boxer 207, tennis player 211, etc.), entrepreneurs 208, politicians 209, or events (e.g., circus 210). Advantageously, talent, tour promoters, and event organizers can pre-reserve their availability on the calendaring system 203. Furthermore, talent and tour promoters can select venues (e.g., venue 213 or venue 214) of their choice for performances. Accordingly, in some implementations, talent and tour promoters can pre-schedule or reserve dates and times for bookings along with suitable venues of their preference.

In one or more examples of the present invention, preferences may be associated with venue profiles on the venue platform 205. For example, the preferences associated with the venue profiles stored in the venue platform 205 may include approved or preferred genre(s), for events, specific dates and times for event reservations, and a minimum number of attendees for events.

Accordingly, user subscribers 201 can initiate inquiry notifications for events on the system 200 based upon the availability and venue preferences of talent, tour promoters, and event organizers on the system 200. Likewise, talent, tour promoters, and tour event organizers can initiate inquiry notifications for events to determine a level of interest for events and performances within a specific geo. Moreover, venue personnel can initiate inquiry notifications for events based upon talent availability to determine the level of interest for specific shows.

System 200 can send inquiry notifications to user subscribers within a network 215 according to the present location of one or more client devices assigned to each user within a particular geo. Therefore, in one or more implementations of the present invention, the present location of the user subscriber's client device determines whether the user subscriber receives inquiry notifications.

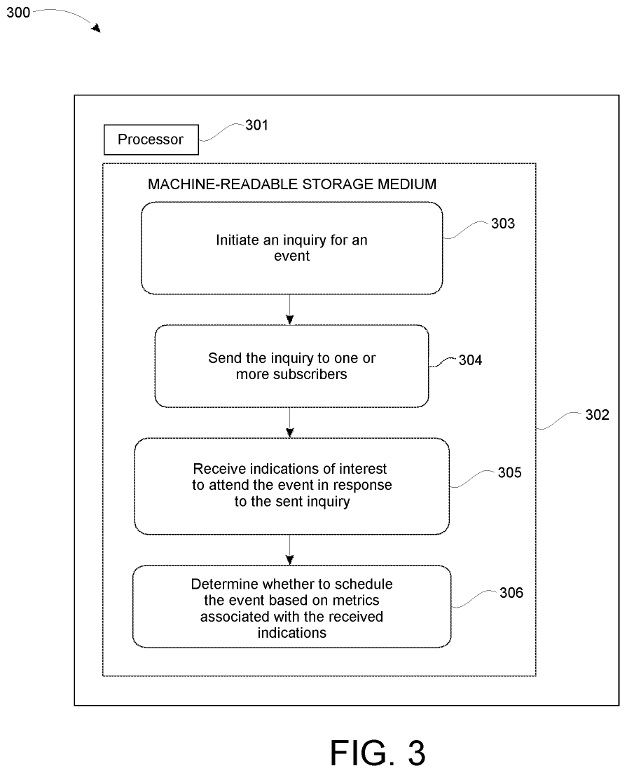

FIG. 3 is an illustration of a computing system 300 according to one or more examples of the present invention. The computing system 300 may include a non-transitory computer readable medium 302 that includes computer executable instructions 303-306 stored thereon that, when executed by one or more processing units 301 (one processor shown), causes the one or more processing units 301 to effect a scheduling process consistent with the present invention.

Computer readable medium 302 includes computer executable instructions 303 which include instructions to initiate an inquiry notification for an event. As there may be several user subscribers which may be interested in initiating a first set of inquiry notifications for its favorite band to perform live events at local venues, the present invention is amenable to include policy controls to gate inquiry notification requests. For example, a policy instituted by a software application which employs the present invention may provide that a minimum number of user subscribers must also initiate the first set of inquiry notifications in order for an inquiry notification for a particular talent, venue, location, dates and times, etcetera to be sent to user subscribers to attend events.

In yet another example, a software application which employs the present invention may give preference to certain user subscribers to initiate the first set of inquiry notifications on the system. For example, a policy instituted by a software application which employs the present invention may provide that a user subscriber initiate inquiry notifications if the user subscriber has attained a certain degree of social status. For instance, a user subscriber's social status may be indicative of its number of Facebook friends and level of engagement on a social media platform. Accordingly, the present invention provides a platform for influencers to propose events that its peers are likely to attend. The aforementioned policies may also include demographics of the geo where the event is to be hosted to help dictate which user subscribers within the geo are to receive the first set of inquiry notifications.

In addition, computer executable instructions 304 include instructions to send the inquiry notification to one or more user subscribers of a software application on a network. The inquiry notification may be sent via an electronic or digital means in the form of a notification such as, but not limited to, an in-app (software application) message, SMS, MMS, etcetera. The inquiry notification may be sent in various other means known in the art according to a user subscriber's profile setting or other capability of a software application which employs the present invention. For example, the first set of inquiry notifications may be sent via an API to an external software application (e.g., social media application). In addition, an inquiry notification may comprise several inquiries which pose questions to a select group of user subscribers regarding its interest to attend various events.

Next, computer readable medium 302 includes computer executable instructions 305 which includes instructions to receive indications of interest to attend the event. Furthermore, computer readable medium 302 includes computer executable instructions 306 which include instructions to determine whether to schedule the event based upon metrics associated with the received indications of interest.

Computer readable medium 302 may also include computer executable instructions 307 to schedule the event and to reserve talent when the metrics meet a pre-defined threshold. In some implementations, the pre-defined threshold may be based upon a talent's pre-defined criteria (e.g., minimum number of indications of interest). For example, a recording artist may configure a settings profile such that events can be scheduled automatically if a minimum number of user subscribers express an interest to attend an event at a pre-authorized venue.

For instance, a talent's profile settings may enable automatic reservations for an event if the received indications of interest by user subscribers exceed 5,000 confirmations for a pre-authorized venue with a minimum capacity of 25,000 persons (e.g., at least twenty-five percent of a venue's capacity).

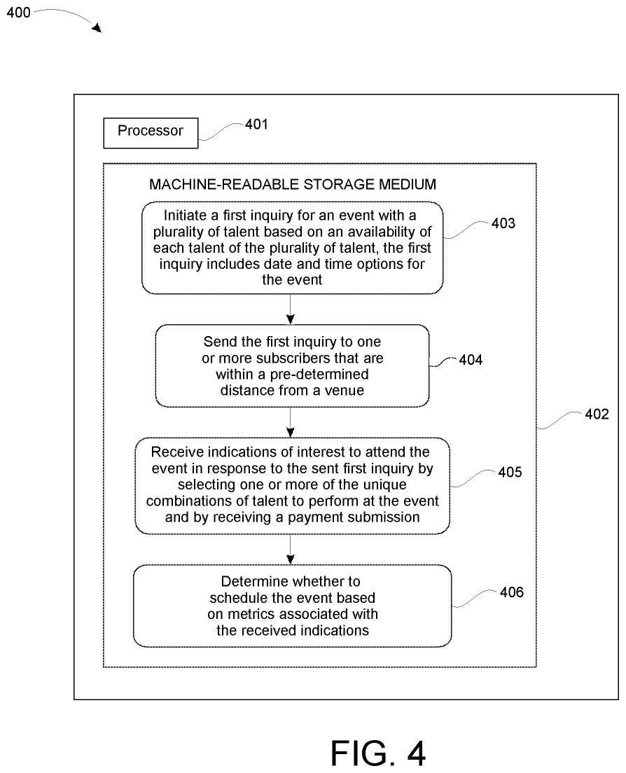

FIG. 4 is an illustration of a computing system 400 according to one or more examples of the present invention. The computing system 400 includes a non-transitory computer readable medium 402 that includes computer executable instructions 403-406 stored thereon that, when executed by one or more processing units 401 (one processor shown), causes the one or more processing units 401 to effect a scheduling process consistent with the present invention.

Computer readable medium 402 include computer executable instructions 403 which includes instructions to initiate a first inquiry notification for an event with a plurality of talent based upon talent availability. The first inquiry notification may include date and time options for the event. In some implementations, the first inquiry notification includes talent combination options to perform at an event. For example, the first inquiry notification may include an option for Talents A, B, C, and D; Talents A, F, G, and H; and Talents B, D, E, and G along with the times that the talent are available for scheduling. Accordingly, the present invention facilitates the capability to send user subscribers options for acts that they would like to see perform at a show. Likewise, in response, the user subscribers can rate and choose the talent options according to their own personal preferences.

Computer readable medium 402 include computer executable instructions 404 which include instructions to send the first inquiry notification to one or more user subscribers of a software application that are within a pre-defined distance (e.g., pre-defined radius) from a venue or set of venues. The pre-defined distance may be set according to default settings. For instance, the pre-defined distance may be set based upon the demographics in the proposed event location. Therefore, a software application which employs the present invention may be configured to set the pre-defined distance based upon the city population of the proposed event location. For instance, if a proposed event location is in a metropolitan area, the pre-defined distance from a venue may be less than the pre-defined distance of user subscribers which are from another venue that is located in a rural area which has a relative sparse population density.

Additionally, an inquiry notification may include two or more proposed venues for an event and therefore may be sent to user subscribers which are within a pre-defined distance from each of the venue options included within the inquiry notifications. For example, if Venues A and B are within 30 miles from each other, and the pre-defined distance is 75 miles, user subscribers which are located within a 75-mile radius, respectively, of Venues A and B will receive inquiry notifications regarding its interest to attend an event. Therefore, some user subscribers shall receive inquiry notifications due to its proximity to Venue A, while other user subscribers shall receive inquiry notifications due to its proximity to Venue B. Moreover, other user subscribers shall receive inquiry notifications due to its proximity to Venus A and B.

Additionally, the pre-defined distance may depend upon the maximum capacity of a selected venue. For instance, the pre-defined distance may be a ratio of a number of user subscribers that are proximate to the proposed venue relative to the maximum capacity of the proposed venues.

Next, computer executable instructions 405 include instructions to receive indications of interest to attend the event by selecting one or more of talent combination options to perform at the event and by receiving a deposit payment. The deposit payment may be in any acceptable form known in the art. For example, a user subscriber may submit an indication of interest by submitting a deposit payment via the software application. In one or more examples of the present invention, the deposit payment may constitute a default fee (e.g., $50) or may be a fraction of a proposed fee to attend the event (e.g., 10%). The deposit payment may be sent to at least one of an escrow account, the booked talent on the venue that is to host the event. In another implementation, the received indications of interest may be in a form of a receipt of a Like indication within the software application.

Next, computer executable instructions 406 includes instructions to determine whether to schedule the event based upon metrics associated with the received indications of interest. The metrics associated with the received indications of interest may include a raw number of user subscribers which have expressed an interest to attend an event evidenced by the submission of deposit payments, a percentage of user subscribers which expressed interest relative to the number of user subscribers which were sent the first set of inquiry notifications, and the profiles of the user subscribers which initiated the inquiry notification for the event.

It should be understood by those having ordinary skill in the art that several user subscribers may initiate requests for the first set of inquiry notifications for talent to attend an event. In some implementations, a number of inquiry notifications requested for a particular talent for a particular geo is tallied and sent to user subscribers within the particular geo once the number of requests exceeds a minimum number. For example, if a number of inquiry notifications request for a recording artist to perform at a venue in the San Francisco Bay Area exceeds a location of a venue's capacity, an inquiry notification is then sent to user subscribers within the San Francisco Bay Area in accordance with other user and default settings.

As such, the computing system 400 may provide for a manner to limit inquiry notifications initiations to those which are in demand by user subscribers within a particular geo. The demand for a particular geo may be greater in one region of the country than another region of the country. Therefore, a demand for talent to attend an event in the former area may lead to the dispatch of inquiry notifications in response to a threshold number of inquiry notification requests rather than the latter region where requests to initiate the first set of inquiry notifications are due to the weaker demand. Moreover, computer readable medium 402 includes computer executable instructions which include instructions to send the inquiry notification to user subscribers which have attended past events at the venue according to profiles of the user subscribers.

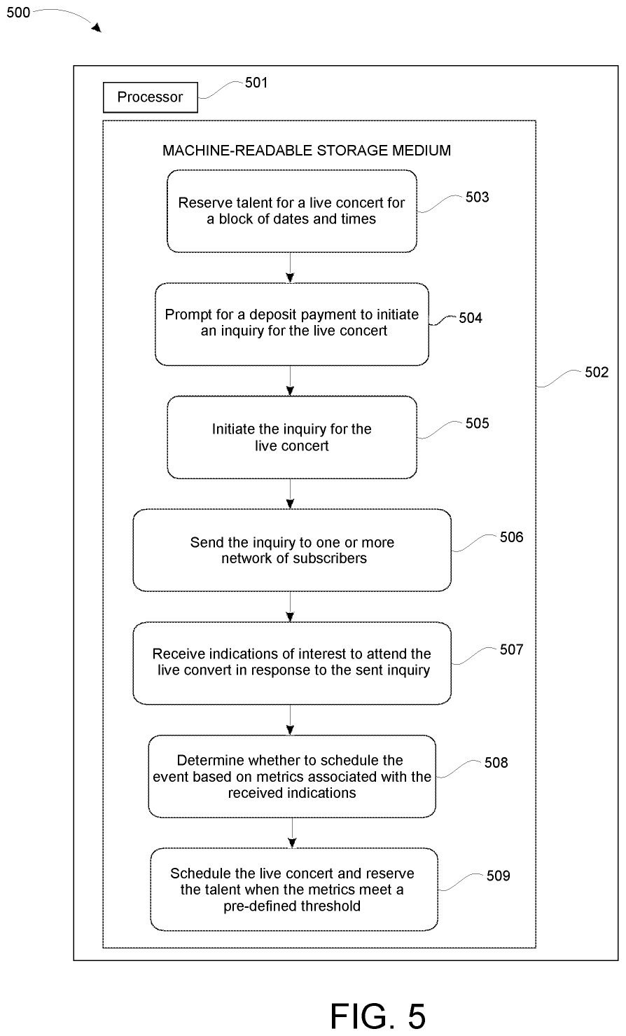

FIG. 5 is an illustration of a computing system 500 according to one or more examples of the present invention. The computing system 500 may include a non-transitory computer readable medium 502 that includes computer executable instructions 503-509 stored thereon that, when executed by one or more processing units 501 (one processor shown), causes the one or more processing units 501 to effect a scheduling process consistent with the present invention.

Computer readable medium 502 includes computer executable instructions 503 which include instructions to book talent for a live concert for a block of dates and times. Next, computer executable instructions 504 include instructions to prompt for a deposit payment as a condition to initiate an inquiry notification for the live concert. Accordingly, deposit payments may mitigate bad faith inquiry notifications from propagating throughout the system. Additionally, computer readable medium 502 also includes computer executable instructions 505 which include instructions to initiate the first set of inquiry notification for the live concert.

Next, computer readable medium 502 includes computer executable instructions 506 which include instructions to send the inquiry notifications to one or more network of user subscribers. Further, computer executable instructions 507 include instructions to receive indications of interest to attend the live concert. Additionally, computer executable instructions 508 include instructions to determine whether to schedule the live concert based upon metrics associated with the received indications of interest. Lastly, computer readable medium 502 which includes computer executable instructions 509 include instructions to schedule the live concert and to book talent when metrics meet a pre-defined threshold.

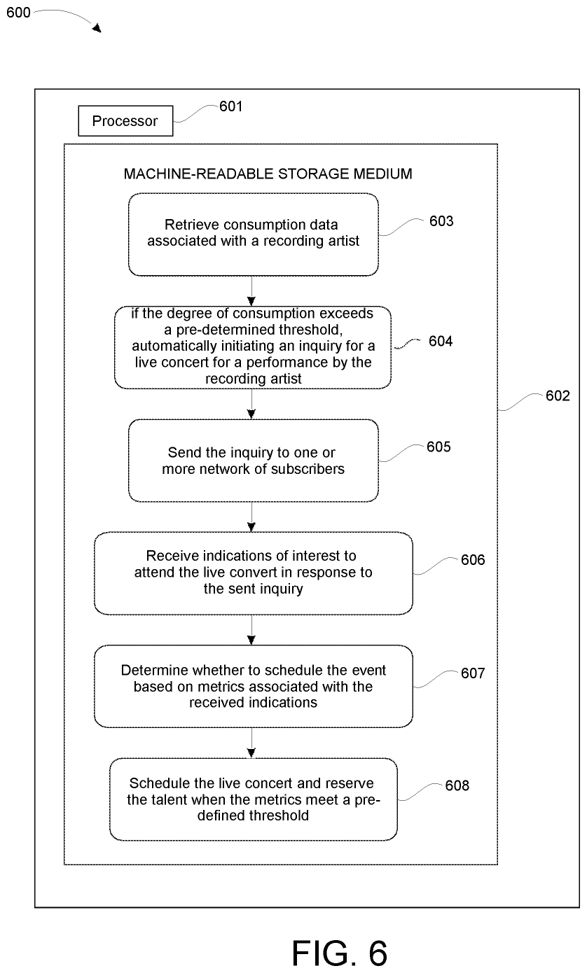

FIG. 6 is an illustration of a computing system 600, according to one or more examples of the present invention. The computing system 600 may include a non-transitory computer readable medium 602 that includes computer executable instructions 603-607 stored thereon that, when executed by one or more processing units 601 (one processor shown), causes the one or more processing units 601 to effect a scheduling process consistent with the present invention.

Computer readable medium 602 includes computer executable instructions 603 which include instructions to retrieve media consumption data associated with a recording artist. The consumption data may be retrieved from one or more media platforms (e.g., social media platforms, video platforms, etc.) and may include the degree of media consumed for a recording artist, the demographic data associated with the consumers of this media, and a rate of change of the consumption of media, etc.

Next, computer readable medium 602 includes computer executable instructions 604 which include instructions to automatically initiate an inquiry notification for a performance by the recording artist in response to determining whether the media consumption exceeds a pre-defined threshold. In this example, a recording artist may have a profile on a software application which employs the present invention for bookings and may have settings that limit bookings to certain timeframes and venues. Moreover, the degree of media consumption may be at least one of a number of streams, views, or downloads.

Further, computer readable medium 602 includes computer executable instructions 605 which include instructions to send the inquiry notifications to one or more network of user subscribers of a software application based upon pre-defined rules. Next, computer executable instructions 606 include instructions to receive indications of interest to attend the performance. Next, computer readable medium 602 includes computer executable instructions 607 which include instructions to determine whether to book the talent for the performance based upon metrics associated with the received indications of interest.

In addition, a platform which hosts media associated with a plurality of talent can be accessed to gain media data associated with talent. For example, a music streaming platform (or sub-platform) may provide details of a number of streams along with demographic information of the consumers which requested the streams.

A software application which employs the present invention may have an API to retrieve media data from music streaming platforms and then automatically initiates and sends inquiry notifications to user subscribers media in certain geos based upon the demographic information associated with the retrieved data. Accordingly, the present invention can be adapted to automatically query user subscribers within a specific geo about their interests to attend events to see talent according to quantifiable data retrieved from a media platform.

In yet another example, a software application which employs the present invention may prompt a user subscriber to initiate an inquiry notification to host an event for a performance of talent in response to the user subscriber's purchase of a good or service that is associated with the talent. For example, if a user subscriber streams a song or downloads an album of a particular recording artist, the user subscriber may later receive a notification inquiring about an interest to attend a live performance from the recording artist.

In another example, during an election season, a platform which hosts media content (e.g., videos) of politicians may be retrieved (e.g., via an API) of its media data such that a software application which employs the present invention can determine, based upon a set of policies, when to initiate inquiry notifications to a network of user subscribers within a specific geo regarding its interest to attend a political event.

For instance, retrieved media data may reveal that a politician is popular in one region, or alternatively, unpopular in other regions. If the politician elects within its profile settings to only host rallies in regions that it is most popular, in an attempt to raise the maximum amount of campaign funds, the politician can elect an auto-reservation feature within the software application to autonomously schedule events and venues within the regions where the politician is most popular. According to this example, both the venues' availability and the politician's availability may be taken into account prior to initiating inquiry notifications for these events.

It should be understood by those having ordinary skill in the art that the present invention is not limited to a software application that retrieves media data from a single platform. A software application which employs the present invention may retrieve and aggregate media data from several platforms.

Furthermore, the software application may have the capability to track user subscribers' purchases so long as each user subscriber consents to such tracking within their software application settings. For example, the profile settings of an underground music artist may be set to prompt user subscribers to initiate inquiry notifications for performances upon their purchase of the artist's music. Alternatively, a politician's profile settings could prompt a user subscriber to initiate inquiry notifications for an event with the politician's attendance in response to the user subscriber's financial pledge that exceeds a pre-defined threshold.

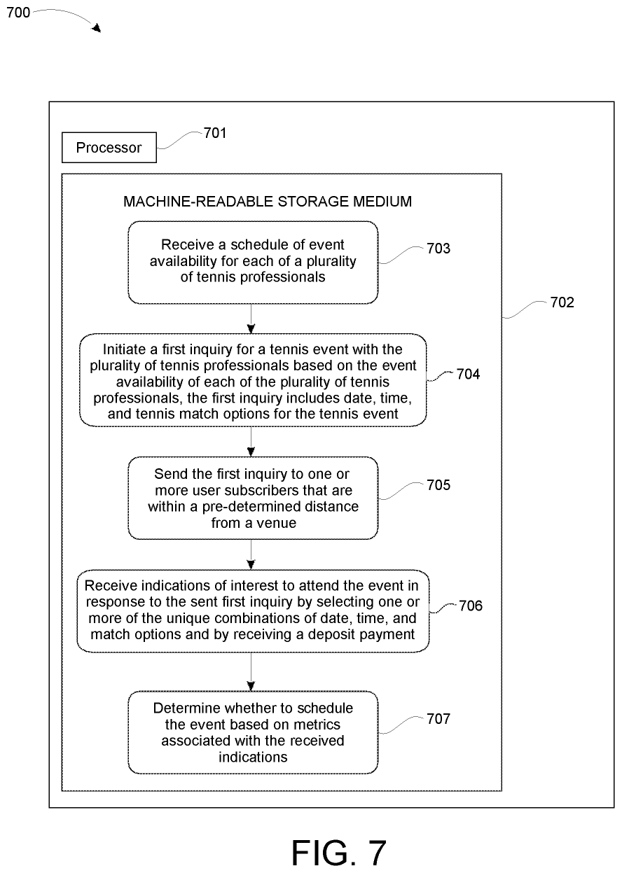

FIG. 7 is yet another illustration of a computing system 700 according to one or more examples of the present invention. The computing system 700 may include a non-transitory computer readable medium 702 that includes computer executable instructions 703-707 stored thereon that, when executed by one or more processing units 701 (one processor shown) causes the one or more processing units 701 to effect a scheduling process consistent with the present invention.

Computer readable medium 702 includes computer executable instructions 703 which include instructions to receive a schedule of event availability for each of a plurality of tennis professionals. A plurality of tennis professionals may include collegiate, semi-professional, or professional tennis players. Computer readable medium 702 includes computer executable instructions 704 which include instructions to initiate a first set of inquiry notifications for a tennis event with the plurality of tennis professionals based upon the availability of each tennis professional. In some embodiments, the first set of inquiry notifications includes date, time, and tennis match options for the tennis event.

In addition, computer readable medium 702 includes computer executable instructions 705 which include instructions to send the first set of inquiry notifications to one or more user subscribers that are within a pre-defined distance from a venue. Furthermore, computer readable medium 702 includes computer executable instructions 706 which include instructions to receive indications of interest to participate in a tennis match by selecting one or more combinations of date, time, and match options or by requesting a deposit payment.

Lastly, computer readable medium 702 includes computer executable instructions 707 which include instructions to determine whether to schedule the event based upon metrics associated with the received indications of interest.

While illustrative implementations of the application have been described in detail herein, it is to be understood that the inventive concepts may be otherwise variously embodied and employed, and that the appended claims are intended to be construed to include such variations, except as limited by the prior art.

Reference throughout this specification to “one implementation” or “an implementation” means that a particular feature, structure, or characteristic described in connection with the implementation is included in at least one implementation of the present invention. Thus, the appearances of the phrases “in one implementation” or “in some implementations” in various places throughout this specification are not necessarily all referring to the same implementation. Furthermore, the particular features, structures, or characteristics may be combined in any suitable manner in one or more implementations.

Systems and methods describing the present invention have been described. It will be understood that the descriptions of some embodiments of the present invention do not limit the various alternative, modified, and equivalent embodiments which may be included within the spirit and scope of the present invention as defined by the appended claims. Furthermore, in the detailed description above, numerous specific details are set forth to provide an understanding of various embodiments of the present invention. However, some embodiments of the present invention may be practiced without these specific details. In other instances, well known methods, procedures, and components have not been described in detail so as not to unnecessarily obscure aspects of the present embodiments.

What is claimed is:

1. A non-transitory machine-readable storage medium containing instructions that, when executed, causes a scheduler to:
initiate a first set of inquiry notifications for an event;
send the first set of inquiry notifications to one or more user subscribers on a network;
receive indications of interest to attend the event; and
determine whether to schedule the event based upon metrics associated with the received indications of interest.

2. The non-transitory machine-readable storage medium of claim 1, further comprising instructions that, when executed, causes the scheduler to book talent for the event for specific dates and times.

3. The non-transitory machine-readable storage medium of claim 2, further comprising instructions that, when executed, causes the scheduler to reserve the event and to book the talent for the event or a specific date and time when the metrics associated with the received indications of interest meet a pre-defined threshold.

4. The non-transitory machine-readable storage medium of claim 3, further comprising instructions that, when executed, causes the scheduler to set the pre-defined threshold based upon the talent's pre-defined criteria for a minimum number of received indications of interest.

5. The non-transitory machine-readable storage medium of claim 4, wherein the pre-defined criteria is a number of received indications of interest exceeds at least twenty-five percent of a proposed venue's capacity.

6. The non-transitory machine-readable storage medium of claim 1, wherein the first set of inquiry notifications includes the date and time options for the event and one or more venues for the event.

7. The non-transitory machine-readable storage medium of claim 1, further comprising instructions that, when executed, causes the scheduler to prompt a user subscriber which created the firs set of inquiry notifications for a deposit payment as a condition for the first set of inquiry notifications to be sent to the one or more user subscribers.

8. The non-transitory machine-readable storage medium of claim 1, wherein the one or more user subscribers is a select group of user subscribers within a network.

9. The non-transitory machine-readable storage medium of claim 1, wherein the

10. The non-transitory machine-readable storage medium of claim 1, wherein the received indications of interest is a receipt of a Like indication.

11. A non-transitory machine-readable storage medium containing instructions that, when executed, causes a scheduler to:
initiate a first set of inquiry notifications for an event with a plurality of talent based upon an availability of the plurality of talent, the first set of inquiry notification includes date and time options for the event;
wherein the first set of inquiry notifications includes talent options to perform at the event;
send the first set of inquiry notifications to one or more user subscribers of a software application that are within a pre-defined distance from avenue;
receive indications of interest to attend the event in response to the sent first inquiry notification by selecting one or more of the talent options to perform at the event and by receiving a deposit payment; and
determine whether to schedule the event based upon metrics associated with the received indications of interest.

12. The non-transitory machine-readable storage medium of claim 11, further comprising instructions that, when executed, causes the scheduler to send the first set of inquiry notifications to user subscribers which have attended past events at the venue according to profiles of the user subscribers.

13. The non-transitory machine-readable storage medium of claim 11, wherein the Deposit payment is a portion of a price to attend the event.

14. The non-transitory machine-readable storage medium of claim 11, further comprising instructions that, when executed, causes the scheduler to send portions of the deposit payment to at least one of an escrow account, the booked talent, and the venue that will host the event.

15. The non-transitory machine-readable storage medium of claim 11, wherein the one or more user subscribers that are within the pre-defined distance from the venue is determined by a present distance of each client device that is associated with the one or more user subscribers.

16. The non-transitory machine-readable storage medium of claim 11, wherein the first set of inquiry notifications is transmitted via a message within a software application.

17. The non-transitory machine-readable storage medium of claim 11, wherein the first set of inquiry notifications is initiated based upon metrics retrieved from media data associated with the talent.

18. The non-transitory machine-readable storage medium of claim 17, wherein the media data includes media consumption data of the talent by the one or more user subscribers.

19. A non-transitory machine-readable storage medium containing instructions that, when executed, causes a scheduler to:
retrieve media consumption data associated with a recording artist;
in response to determining whether the media consumption exceeds a pre-defined threshold, automatically initiating a first set of inquiry notification for a performance by the recording artist;
send the first set of inquiry notifications to one or more user subscribers of a software application;
receive indications of interest to attend the performance; and
determine whether to book the talent on the performance based upon metrics associated with the received indications of interest.

20. The non-transitory machine-readable storage medium of claim 19, wherein the degree of media consumption is at least one of a number of streams, views, and downloads.
